(19) United States
(12) Patent Application Publication
(10) Pub. No.: US 2016/0037559 A1
(43) Pub. Date: Feb. 4, 2016

(54) METHOD AND SYSTEM FOR ESTIMATING AVAILABLE CAPACITY OF AN ACCESS POINT

(71) Applicant: QUALCOMM Incorporated, San Diego, CA (US)

(72) Inventors: Rahul Malik, San Diego, CA (US); Jay Kumar Sundararajan, San Diego, CA (US)

(21) Appl. No.: 14/446,010

(22) Filed: Jul. 29, 2014

(51) Int. Cl. H04W 74/08

(52) U.S. Cl. CPC H04W 74/08

(57) ABSTRACT

A system and method are disclosed that may provide an accurate estimate of an AP's available capacity. The AP may simulate medium access contention operations using actual packets being transmitted from the AP to associated STAs and virtual packets indicative of traffic that would be transmitted to a new STA that is not currently associated with AP. The AP may determine a transmission schedule for the actual packets and virtual packets based on the simulated medium access contention operations, and then determine what portion of the available capacity is allocated to the virtual packets based, at least in part, on the transmission schedule.

### TECHNICAL FIELD

The present embodiments relate generally to wireless networks, and specifically to estimating the available capacity of a wireless access point or network.

### BACKGROUND OF RELATED ART

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and/or maintain a communication link with the WLAN. In a typical WLAN, only one STA may use the wireless medium at any given time, and each STA may be associated with only one AP at a time. Due to the increasing ubiquity of wireless networks, when a STA seeks to join a wireless network, the STA may have a choice between multiple wireless networks and/or between multiple APs that form an extended BSS. At present, STAs may use a received signal strength indicator (RSSI) value to select the best available WLAN to join and/or the best available AP to associate with. RSSI values do not provide any indication of the bandwidth that would be available to the “new” STA. The new STA may use information indicating how many STAs are currently associated with an AP as a gauge of the AP's available capacity. However, the number of STAs currently associated with an AP may not account for current activity (e.g., traffic levels and/or traffic types) of the associated STAs, and therefore may not provide an accurate indication of available capacity.

Thus, it would be desirable for STAs to have a more accurate estimate of the available capacity of APs when deciding which AP to associate with.

### BRIEF DESCRIPTION OF THE DRAWINGS

The present embodiments are illustrated by way of example and are not intended to be limited by the figures of the accompanying drawings, where:

FIG. 1 shows a block diagram of a WLAN system within which the present embodiments may be implemented.

FIG. 2 shows a block diagram of a wireless station (STA) in accordance with some embodiments.

FIG. 3 shows a block diagram of an access point (AP) in accordance with some embodiments.

FIG. 4A shows a block diagram of a packet contention and transmission system of the AP of FIG. 3 in accordance with some embodiments.

FIG. 4B shows a block diagram of a virtual packet contention and transmission system of the AP of FIG. 3 in accordance with some embodiments.

FIG. 5A shows a sequence diagram depicting an example transmission of actual packets from the AP of FIG. 3 in accordance with some embodiments.

FIG. 5B shows a sequence diagram depicting an example simulated transmission of virtual packets and actual packets from the AP of FIG. 3 in accordance with some embodiments.

FIG. 6 shows a block diagram of a virtual packet contention and transmission system of the AP of FIG. 3 in accordance with other embodiments.

FIG. 7 shows an illustrative flow chart depicting an example simulation of media access contention operations in accordance with some embodiments.

Like reference numerals refer to corresponding parts throughout the drawing figures.

### DETAILED DESCRIPTION

The present embodiments are described below in the context of estimating available capacity of WLAN systems for simplicity only. It is to be understood that the present embodiments are equally applicable to estimating available capacity for other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi®” may be used interchangeably herein. In addition, although described below in terms of an infrastructure WLAN system including an AP and a plurality of STAs, the present embodiments are equally applicable to other WLAN systems including, for example, WLANs including a plurality of APs, peer-to-peer (or Independent Basic Service Set) systems, Wi-Fi Direct systems, and/or Hotspots. In addition, although described herein in terms of exchanging data packets between wireless devices, the present embodiments may be applied to the exchange of any data unit, packet, and/or frame between wireless devices. Thus, the term “data packet” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “number” as used herein may refer to an integer value greater than or equal to 0. The term “medium access” as used herein may refer to gaining and/or controlling access to a shared communication medium. The term “transmit opportunity” (TXOP) as used herein may refer to a period of time during which a device may transmit data via the shared communication medium. Further, the term “Traffic Identifier (TID)” refers to a traffic classification indicating the relative priority level of the traffic, and the term “access category” refers to data that may be queued together or aggregated according priority level. Thus, as used herein, the terms “TID,” “access category,” and “priority level” may be used interchangeably. However, it is to be understood that, for at least some embodiments, there may not be a one-to-one correspondence between TID values and access categories. Further, the term “medium share” refers to a proportion of the wireless medium time and/or resources that may be allocated to a particular access category and/or to a particular user.

Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The present embodiments are not to be construed as limited to specific examples described herein but rather to include within their scopes all embodiments defined by the appended claims.

As mentioned above, when a “new” STA seeks to associate with a particular AP (or to join a particular WLAN), it is desirable for the new STA to have information indicating the amount of medium share that would be available to the new STA. Existing methods and systems that indicate the number of STAs currently associated with the AP and/or that provide RSSI values and/or medium utilization values to the new STA may not provide an accurate estimate of medium share that would be available to the new STA. Applicant has found that a more accurate estimation of the AP's available capacity may be derived from the number of active STAs associated with the AP, wherein an active STA may be defined as a STA that is currently exchanging data with the AP. Although providing a better estimate of available medium share than the number of currently associated STAs, the number of active STAs may not account for the priority levels of data transmitted over the wireless medium. Data priority levels are important in determining available medium share because the AP and/or its associated STAs may transmit data of higher priority levels sooner and/or more frequently than data of lower priority levels. Thus, the capacity available to the new STA may depend upon the priority levels of data to be exchanged between the new STA and the AP and the priority levels of existing traffic exchanged among other STAs.

Other factors that may influence the medium share available to the new STA may include the mix of uplink and downlink traffic, the presence of STAs associated with other nearby APs and/or WLANs, and the capabilities of the currently associated STAs. Additionally, the actual capacity available to the new STA may be affected by one or more wireless medium parameters including, for example, RSSI values, channel conditions, interference, and so on.

Accordingly, the present embodiments may provide a more accurate estimate of available capacity (e.g., as compared to conventional systems described above) by considering (1) the priority levels of data corresponding to the new STA relative to the priority levels of data corresponding to the STAs already associated with the AP, (2) the mix of uplink and downlink traffic, (3) the presence of STAs associated with other nearby APs and/or WLANs, (4) the capabilities of the currently associated STAs, and/or (5) interference on the wireless medium. For some embodiments, the AP may simulate medium access contention operations for data having a plurality of different priority levels to generate a simulated data transmission schedule, which in turn may be used to determine how much medium share would be available to the new STA for each of the data priority levels.

Before describing the present embodiments in more detail, Applicant notes that the IEEE 802.11 standards define a distributed coordination function (DCF) that instructs individual STAs (and APs) to “listen” to the medium to determine when the medium is idle (e.g., using a “carrier sense” technique). For example, only when a STA detects that the medium has been continuously idle for a DCF Interframe Space (DIFS) duration may the STA attempt to transmit data on the medium. To prevent multiple devices from accessing the medium at the same time, each device (e.g., each STA and/or AP) may select a random “back-off” number or period. At the end of the DIFS duration, a contention period begins during which each device waits for a period of time determined by its back-off number (e.g., its back-off period) before it attempts to transmit data on the medium. The device that selects the lowest back-off number has the shortest back-off period, and therefore “wins” the medium access contention operation. The winning device may be granted access to the shared wireless medium for a period of time commonly referred to as the transmit opportunity (TXOP), during which the winning device may transmit data over the shared wireless medium.

Data may be selected for transmission over the shared medium according to priority levels, for example, so that higher priority data (e.g., voice data) may be allocated higher transmission priorities than lower priority data (e.g., emails). More specifically, data of different priority levels may be assigned different ranges of back-off numbers so that higher priority data is more likely to win a given medium access contention period than lower priority data (e.g., by assigning lower back-off numbers to higher priority data and assigning higher back-off numbers to lower priority data). The different ranges of back-off numbers may be allocated to different priority levels of data by classifying data into access categories, and then providing a different range of back-off numbers to each access category (AC).

For the example embodiments described herein, data may be assigned to one of four access categories (AC0-AC3): the highest priority data (e.g., voice data) may be assigned to the first access category (AC0); the second highest priority data (e.g., video data) may be assigned to the second access category (AC1); the third highest priority data (e.g., data associated with a “best effort” QoS) may be assigned to the third access category (AC2); and the lowest priority data (e.g., background data) may be assigned to the fourth access category (AC3). Although described herein with respect to four access categories AC0-AC3, the present embodiments are applicable to systems that may include other numbers of access categories or priority levels. More specifically, for some example embodiments, the access categories AC0-AC3 described herein may correspond to the access categories AC_VO, AC_VI, AC_BE, and AC_BK, respectively, associated with one or more of the IEEE 802.11 standards. For other embodiments, the access categories AC0-AC3 described herein may be applicable to access categories or priority levels for other wireless protocols (e.g., cellular and Bluetooth®) and/or to wired protocols (e.g., Internet Protocol, Ethernet, HomePlug, powerline, EPON, EPOC, and so on).

According to the enhanced distributed coordination channel access (EDCA) function described in the IEEE 802.11 standards, each STA is to include a different transmit queue for each access category (AC), and the transmit queues are to independently contend for medium access. Because the AP may serve multiple STAs at the same time, the AP may include a plurality of transmit queues for each AC. More specifically, the AP may classify downlink data (e.g., data to be transmitted to one or more of its associated STAs) based on a traffic identifier (TID) and a destination address (DA). The destination address (DA) indicates to which STA the data is to be transmitted. The TID indicates the priority level of the data, and may thus be mapped to a corresponding access category. By classifying downlink data according to its TID and DA, the AP may aggregate data of the same priority level in a common set of AC queues that select from a corresponding range of back-off numbers. The aggregated data may be transmitted over the wireless medium as aggregated data frames such as, for example, aggregate MAC protocol data units (AMPDUs) and/or aggregate MAC service data units (AMSDUs).

Applicant notes that the time interval between successive contention period wins for a selected access category may be influenced by the number of other access categories simultaneously contending for medium access, by the priority of the selected access category relative to the priorities of the other access categories, by the amount of queued downlink data for each of the access categories, and by the amount of traffic on medium. Applicant has discovered that because the available medium share of an AP may be related to the time interval between successive contention period wins for its access categories, a simulation of medium access contention operations on a per access category basis may provide a more accurate estimate of an AP's available medium share than conventional solutions (e.g., based on the number of STAs associated with the AP). Accordingly, the present embodiments may provide an estimate of an AP's available capacity for each of a plurality of data priority levels by simulating medium access contention operations for each of the plurality of data priority levels, as described in more detail below.

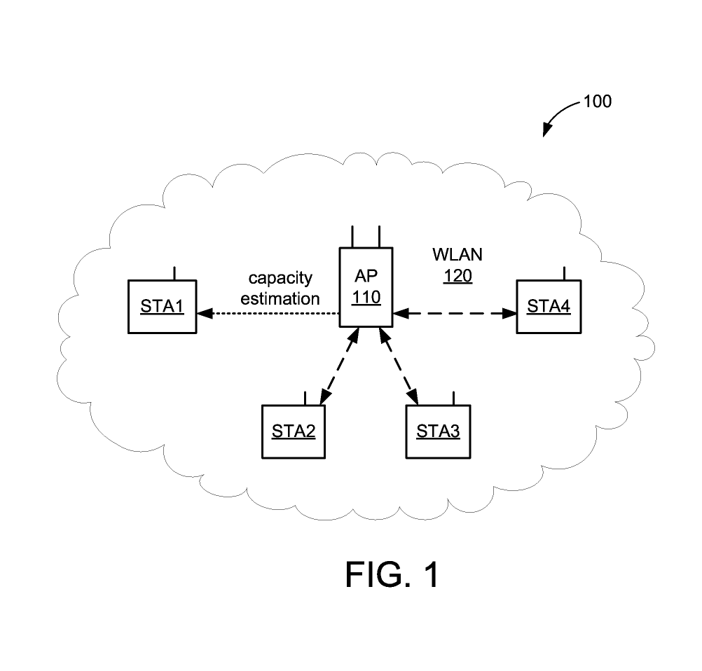

FIG. 1 is a block diagram of a wireless network system 100 within which the present embodiments may be implemented. The system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique MAC address that is programmed therein by, for example, the manufacturer of the access point. Similarly, each of STA1-STA4 is also assigned a unique MAC address.

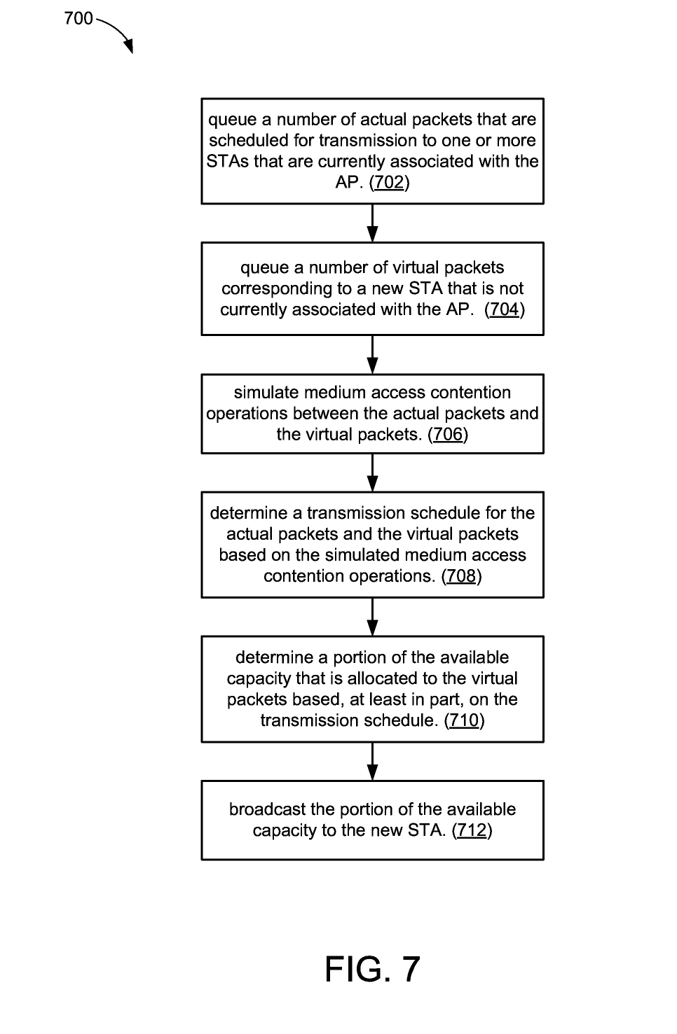

The stations STA1-STA4 may be any suitable Wi-Fi enabled wireless devices including, for example, cell phones, personal digital assistants (PDAs), tablet devices, laptop computers, or the like. For at least some embodiments, stations STA1-STA4 may include a transceiver, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 7.

The AP 110 may be any suitable device that allows one or more wireless devices to connect to a network (e.g., a LAN, WAN, MAN, and/or the Internet) via AP 110 using Wi-Fi, Bluetooth, or any other suitable wireless communication standards. For at least one embodiment, AP 110 may include a transceiver, a network interface, one or more processing resources, and one or more memory sources. The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 7.

For purposes of discussion herein, STA1 is not associated with AP 110, and STA2-STA4 are associated with AP 110. Thus, while STA2-STA4 have an established communication link with AP 110 and currently share the wireless medium (not shown for simplicity) associated with AP 110, STA1 does not have an established communication link with AP 110 and therefore does not currently share the wireless medium associated with AP 110. As a result, STA1 may seek to join WLAN 120 and/or associate with AP 110, and may hereinafter be referred to as the “new” STA.

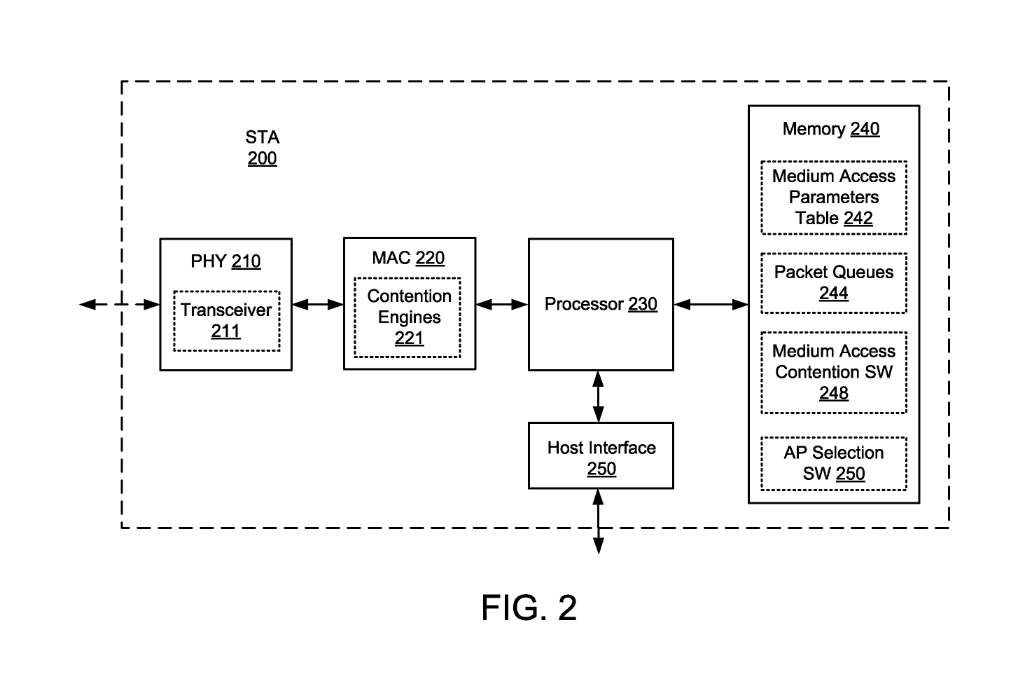

FIG. 2 shows a STA 200 that is one embodiment of at least one of the stations STA1-STA4 of FIG. 1. The STA 200 may include a PHY device 210 including at least a WLAN transceiver 211, a MAC device 220 including a number of contention engines 221, a processor 230, a memory 240, and a host interface 250. The host interface 250 may allow the STA 200 to connect to one or more other devices (e.g., a TV, set-top box, media player, and the like). The transceiver 211 may be used to transmit signals to and receive signals from AP 110 (see also FIG. 1), and may be used to scan the surrounding environment to detect and identify nearby access points (e.g., access points within range of STA 200). For purposes of discussion herein, MAC device 220 is shown in FIG. 2 as being coupled between PHY device 210 and processor 230. For actual embodiments, PHY device 210, MAC device 220, processor 230, and/or memory 240 may be connected together using one or more buses (not shown for simplicity).

The contention engines 221 may contend for access to the shared wireless medium, and may also store packets for transmission over the shared wireless medium. The STA 200 may include one or more contention engines 221 for each of the plurality of different access categories. For other embodiments, the contention engines 221 may be separate from MAC device 220. For still other embodiments, the contention engines 221 may be implemented as one or more software modules (e.g., stored in memory 240 or stored in memory provided within MAC device 200) containing instructions that, when executed by processor 230, perform the functions of contention engines 221.

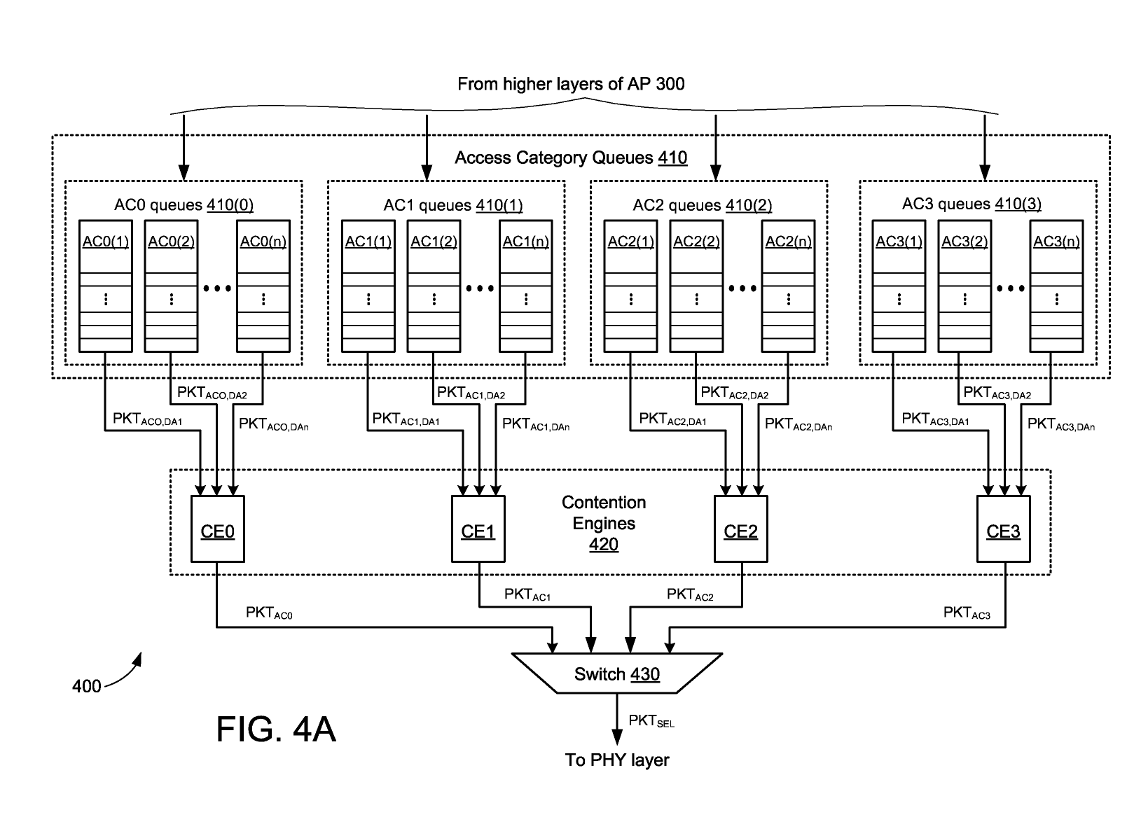

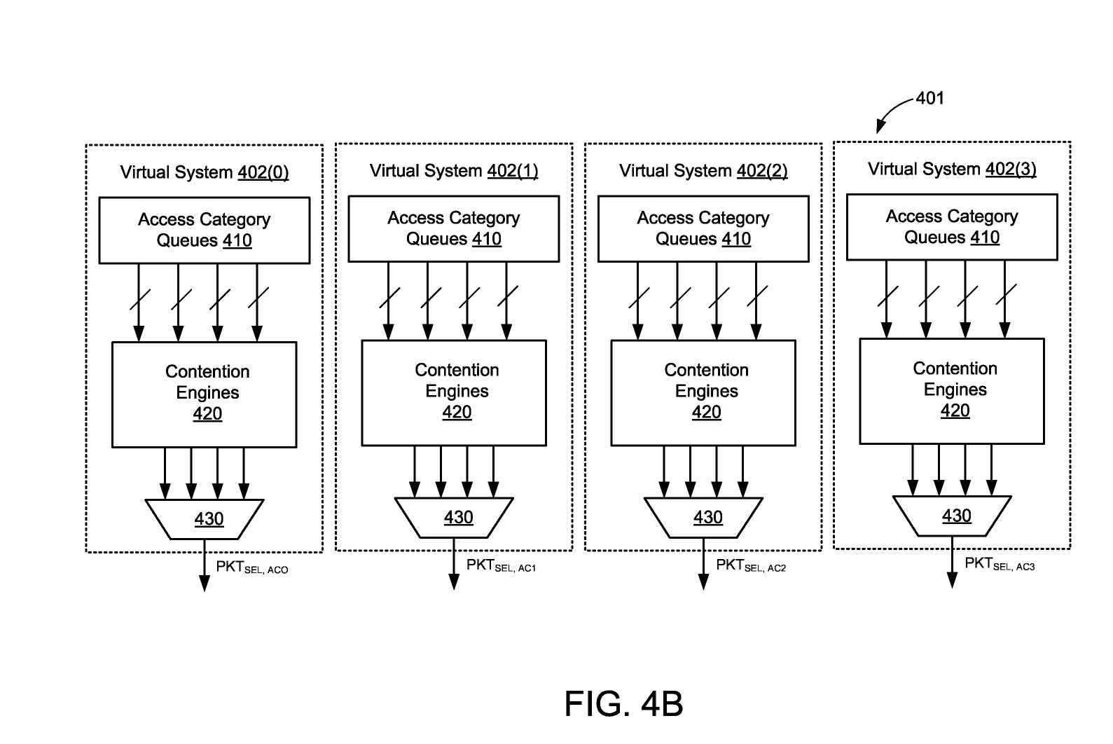

Memory 240 may include a medium access parameters table 242 that may store a number of medium access parameters including, for example, transmission schedules, contention windows, contention window sizes, back-off periods, random back-off numbers, and/or other information associated with contending for and/or controlling access to the wireless medium of the WLAN 120 of FIG. 1. Memory 240 may include a number of packet queues 244. The packet queues 244 may store packets to be transmitted from STA 200 to an associated AP (or other STAs). For some embodiments, the memory 240 may include one or more packet queues 244 for each of a plurality of different priority levels or access categories, for example, as described in more detail below with respect to FIGS. 4A-4B.

Memory 240 may also include a non-transitory computer-readable medium (e.g., one or more nonvolatile memory elements, such as EPROM, EEPROM, Flash memory, a hard drive, and so on) that can store the following software modules:
a medium access contention software module 248 to contend for, to control, and/or to relinquish access to the wireless mediums such as the wireless medium associated with AP 110 of FIG. 1; and
an AP selection software module 250 to select one of a number of nearby APs with which to associate.
   Each software module includes instructions that, when executed by processor 230, cause STA 200 to perform the corresponding functions. The non-transitory computer-readable medium of memory 240 thus includes instructions for performing all or a portion of the STA-side operations of the method of FIG. 7.

Processor 230, which is shown in the example of FIG. 2 as coupled to PHY device 210 and transceiver 211, to MAC device 220 and contention engines 221, and to memory 240, may be any suitable processor capable of executing scripts or instructions of one or more software programs stored in STA 200 (e.g., within memory 240). For example, processor 230 may execute medium access contention software module 248 to contend for, to control, and/or to relinquish access to a wireless medium. Processor 230 may also execute AP selection software module 250 to select one of a number of nearby APs with which to associate.

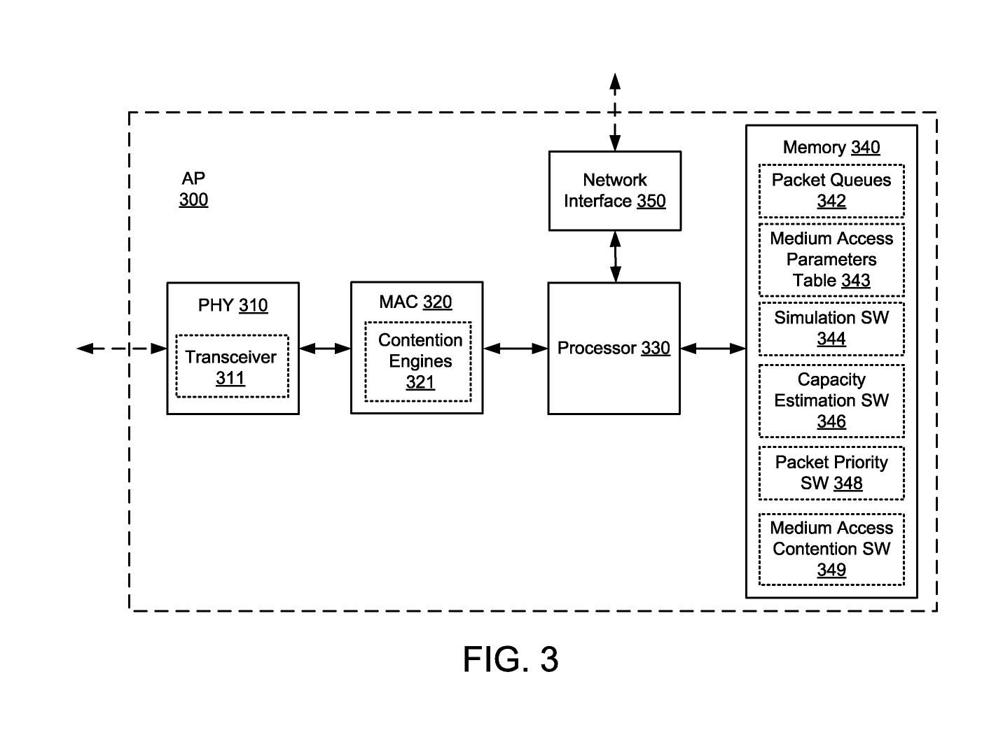

FIG. 3 shows an example of an AP 300 that is one embodiment of AP 110 of FIG. 1. AP 300 includes a PHY device 310 including at least a transceiver 311, a MAC device 320 including at least a number of contention engines 321, a processor 330, a memory 340, and a network interface 350. The transceiver 311 may be used to communicate wirelessly with one or more STAs, with one or more other APs, and/or with other suitable devices. The network interface 350 may be used to communicate with a WLAN server (not shown for simplicity) associated with WLAN 120 of FIG. 1 either directly or via one or more intervening networks and to transmit signals. Processor 330, which is coupled to PHY device 310 and transceiver 311, to MAC device 320 and contention engines 321, to memory 340, and to network interface 350, may be any suitable processor capable of executing scripts or instructions of one or more software programs stored in AP 300 (e.g., within memory 340). For purposes of discussion herein, MAC device 320 is shown in FIG. 3 as being coupled between PHY device 310 and processor 330. For actual embodiments, PHY device 310, MAC device 320, processor 330, memory 340, and/or network interface 350 may be connected together using one or more buses (not shown for simplicity).

The contention engines 321 may contend for access to the shared wireless medium, and may also store packets for transmission over the shared wireless medium. For some embodiments, AP 300 may include one or more contention engines 321 for each of the plurality of different access categories, for example, as described in more detail below with respect to FIG. 4A. For other embodiments, the contention engines 321 may be separate from MAC device 320. For still other embodiments, the contention engines 321 may be implemented as one or more software modules (e.g., stored in memory 340 or within memory provided within MAC device 320) containing instructions that, when executed by processor 330, perform the functions of contention engines 321 described below, for example, with respect to FIGS. 4A, 4B, 5, 6, and 7.

Memory 340 may include a number of packet queues 342. The packet queues 342 may store packets to be transmitted from AP 300 to one or more STAs. For some embodiments, the memory 340 may include one or more packet queues 342 for each of a plurality of different priority levels or access categories, for example, as described in more detail below with respect to FIG. 4A. In addition, for at least some embodiments, memory 340 may include packet queues for a plurality of different destinations (e.g., STAs), for example, as described in more detail below with respect to FIG. 4A. In addition at least in some embodiments, memory 340 may contain packet queues organized on a per-destination address, per-priority level as described in more detail below in the context of FIG. 4A. Memory 340 may also include a medium access parameters table 343 that may store a number of medium access parameters including, for example, transmission schedules, contention windows, contention window sizes, back-off periods, random back-off numbers, and/or other information associated with contending for and/or controlling access to the wireless medium of the WLAN 120 of FIG. 1.

Memory 340 may also include a non-transitory computer-readable medium (e.g., one or more nonvolatile memory elements, such as EPROM, EEPROM, Flash memory, a hard drive, and so on) that can store the following software modules:
a simulation software module 344 to simulate medium access contention operations for actual packets corresponding to STAs associated with AP 300 and virtual packets corresponding to a STA seeking to associate with AP (e.g., as described for operation 706 of FIG. 7);
a capacity estimation software module 346 to estimate the capacity available to the STA seeking to associate with the AP 300 (e.g., as described for operations 708 and 710 of FIG. 7);
a packet priority software module 348 to determine the priority level or access category for the actual packets and/or for the virtual packets; and
a medium access contention software module 349 to contend for, to control, and/or to relinquish access to the wireless mediums such as the wireless medium associated with AP 110 of FIG. 1.
   Each software module includes instructions that, when executed by processor 330, cause AP 300 to perform the corresponding functions. The non-transitory computer-readable medium of memory 340 thus includes instructions for performing all or a portion of the AP-side operations of the method of FIG. 7.

Processor 330, which is shown in the example of FIG. 3 as coupled to transceiver 311 of PHY device 310 via MAC device 320, to memory 340, and to network interface 350, may be any suitable processor capable of executing scripts or instructions of one or more software programs stored in AP 300 (e.g., within memory 340). For example, processor 330 may execute simulation software module 344 to simulate medium access contention operations for actual packets corresponding to STAs associated with AP 300 and virtual packets corresponding to a STA seeking to associate with AP 300. Processor 330 may also execute capacity estimation software module 346 to estimate the capacity available to the STA seeking to associate with the AP 300. Processor 330 may also execute packet priority software module 348 to determine the priority level or access category for the actual packets and/or for the virtual packets.

FIG. 4A depicts a packet contention and transmission system 400 of the AP 300 of FIG. 3. For some embodiments, the system 400 may be implemented by or correspond to MAC device 320, processor 330, and/or memory 340 of FIG. 3. For other embodiments, the system 400 may be a separate device or chip coupled to PHY device 310, MAC device 320, processor 330, and memory 340 of FIG. 3. The system 400 is shown to include access category queues 410, contention engines 420, and a switch 430. The access category queues 410, which may be one embodiment of the packet queues 342 of FIG. 3, includes four sets of AC packet queues 410(0)-410(3) that may receive data packets from an upper layer (not shown for simplicity) of the AP 300 (e.g., after packet classification operations that determine the TID and DA of downlink data to be queued in the access category queues 410).

The first set of packet queues 410(0) is to queue downlink data classified by a TID corresponding to the first access category (AC0), and includes a plurality of individual packet queues AC0(1)-AC0(n) each for storing packets to be transmitted to a corresponding one of a plurality of destination addresses DA1-DAn. The second set of packet queues 410(1) is to queue downlink data classified by a TID corresponding to the second access category (AC1), and includes a plurality of individual packet queues AC1(1)-AC1(n) each for storing packets to be transmitted to a corresponding one of the plurality of destination addresses DA1-DAn. The third set of packet queues 410(2) is to queue downlink data classified by a TID corresponding to the third access category (AC2), and includes a plurality of individual packet queues AC2(1)-AC2(n) each for storing packets to be transmitted to a corresponding one of the plurality of the destination addresses DA1-DAn. The fourth set of packet queues 410(3) is to queue downlink data classified by a TID corresponding to the fourth access category (AC3), and includes a plurality of individual packet queues AC3(1)-AC3(n) each for storing packets to be transmitted to a corresponding one of the plurality of destination addresses DA1-DAn.

As noted above, each of the destination addresses DA1-DAn identifies a corresponding STA to which the AP 300 may transmit data. For purposes of discussion herein, STA1 has a destination address of DA1, STA2 has a destination address of DA2, STA3 has a destination address of DA3, and STA4 has a destination address of D4. Thus, for the first access category AC0, packet queue AC0(1) may store packets to be delivered to STA1, packet queue AC0(2) may store packets to be delivered to STA2, and so on; for the second access category AC1, packet queue AC1(1) may store packets to be delivered to STA1, packet queue AC1(2) may store packets to be delivered to STA2, and so on; for the third access category, packet queue AC2(1) may store packets to be delivered to STA1, packet queue AC2(2) may store packets to be delivered to STA2, and so on; for the fourth access category AC3, packet queue AC3(1) may store packets to be delivered to STA1, packet queue AC3(2) may store packets to be delivered to STA2, and so on.

The contention engines 420, which may be one embodiment of contention engines 321 of FIG. 3, are shown to include four individual contention engines CE0-CE3. The first contention engine CE0 includes an input to receive packets from the first set of packet queues 410(0), includes an output coupled to switch 430, and is to contend for medium access on behalf of the first access category AC0. The second contention engine CE1 includes an input to receive packets from the second set of packet queues 410(1), includes an output coupled to switch 430, and is to contend for medium access on behalf of the second access category AC1. The third contention engine CE2 includes an input to receive packets from the third set of packet queues 410(2), includes an output coupled to switch 430, and is to contend for medium access on behalf of the third access category AC2. The fourth contention engine CE3 includes an input to receive packets from the fourth set of packet queues 410(3), includes an output coupled to switch 430, and is to contend for medium access on behalf of the fourth access category AC3.

Each of the contention engines CE0-CE3 is responsible for contending for medium access for its corresponding access category. To ensure that access categories associated with higher data priority levels are granted medium access faster and/or more frequently than access categories associated with lower data priority levels, the contention engines CE0-CE3 may select from different ranges of contention period back-off values. More specifically, the contention engines associated with higher priority access categories select from a lower range of back-off values than the contention engines associated with lower priority access categories. In this manner, contention engines associated with higher priority access categories may have a greater chance of winning medium access for any given contention period than contention engines associated with lower priority access categories. Thus, for the present embodiments, contention engine CE0 may select from the lowest range of back-off values, contention engine CE1 may select from the second lowest range of back-off values, contention engine CE2 may select from the third lowest range of back-off values, and contention engine CE3 may select from the highest range of back-off values. For at least some embodiments, the numerical ranges from which the contention engines CE0-CE3 select back-off values overlap one another.

The switch 430 includes inputs to receive packets from contention engines CE0-CE3, and an output coupled to a PHY layer (e.g., transceiver 311 of FIG. 3) of AP 300. In operation, the switch 430 forwards one of the packets PKT_{AC0}-PKT_{AC3} provided from respective contention engines CE0-CE3 as the selected packet (PKT_{SEL}) to the PHY layer, which in turn transmits PKT_{SEL} on the wireless medium. More specifically, the one of contention engines CE0-CE3 that wins medium access for a given contention period forwards the corresponding one of PKT_{AC0}-PKT_{AC3} as PKT_{SEL} to be transmitted onto the wireless medium.

For some embodiments, the contention and transmission system (not shown for simplicity) of the STA 200 of FIG. 2 may be similar to the contention and transmission system 400 of FIG. 4A, except that in the STA 200 there may be only one queue for each of access categories AC0-AC3 (e.g., because the STA typically transmits data only to an associated AP, and thus there is only one DA value for uplink data queued in the STA). For other embodiments, the contention and transmission system of the STA 200 of FIG. 2 may include separate DA packet queues for each access category, which may allow the STA to support transmission of traffic for multiple DAs.

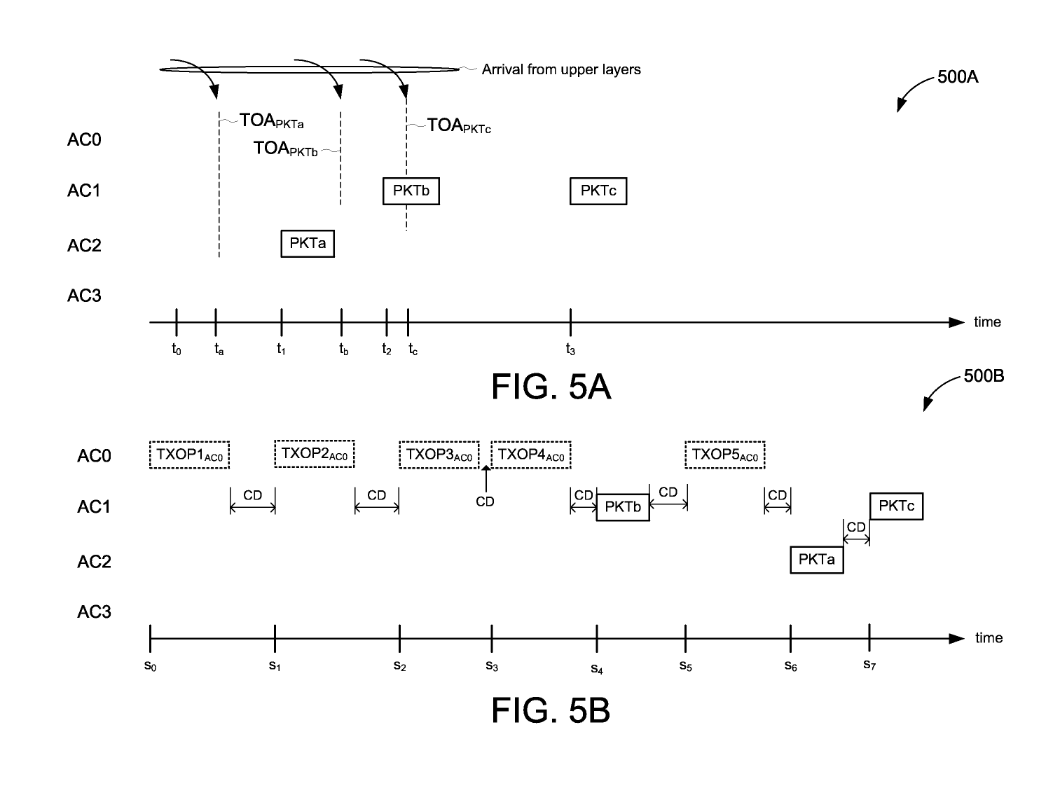

FIG. 5A is a sequence diagram 500A depicting an example transmission of actual packets from the AP 300 of FIG. 3 in accordance with some embodiments. As depicted in FIG. 5A, three actual packets (PKTa, PKTb, PKTc) are received into the packet queues 410 from the upper layer of the AP 300 at different times, which are denoted herein as the packets' time of arrival (TOA). The packets PKTa, PKTb, and PKTc are subsequently transmitted onto the wireless medium after different time delays. For the example of FIG. 5A, packet PKTa is classified as belonging to the third access category AC2, and packets PKTb and PKTc are classified as belonging to the second access category AC1.

More specifically, referring also to FIG. 4A, PKTa arrives into the AC2 queues 410(2) at time tₐ, PKTb arrives into the AC1 queues 410(1) at time t_{b}, and PKTc arrives into the AC1 queues 410(1) at time t_{c}. As depicted in FIG. 5A, PKTa is transmitted from the AP 300 at time t₁, PKTb is transmitted from the AP 300 at time t₂, and PKTc is transmitted from the AP 300 at time t₃.

To determine the amount of capacity that would be available to the new STA (e.g., upon associating with AP 300 and joining WLAN 120) in real time, it is desirable to know which access categories the new STA's traffic belongs to, for example, because contention engines corresponding to different data access categories select from different ranges of back-off numbers when contending for medium access. Thus, in accordance with the present embodiments, the AP 300 may simulate medium access contention operations using actual packets to be transmitted from the AP 300 and a number of virtual packets associated with a selected access category. The simulated medium access contention operations may be used to estimate what portion of the medium would be available to serving data intended for the new STA for data associated with the selected access category in the presence of actual data being transmitted from AP 300. In this manner, the present embodiments may provide an estimate of available medium share to the new STA for each of a number of different access categories (e.g., AC0-AC3) in real time. The resulting estimates of available medium share and/or capacity on a per-AC basis for the new STA may allow the new STA to determine whether it is desirable to associate with the AP 300 based on the priority levels of data that the new STA may seek to transmit to and/or receive from the AP 300.

For some embodiments, the AP 300 may include a virtual contention and transmission system that includes different instances of system 400 to simulate medium access contention operations for virtual packets and actual packets for each of a number of different access categories. For example, FIG. 4B shows a virtual contention and transmission system 401 including four virtual systems 402(0)-402(3), where each of the virtual systems 402(0)-402(3) may simulate medium access contention operations for a corresponding one of access categories AC0-AC3. One or more of the virtual systems 402(0)-402(3) may operate in a manner similar to the system 400 of FIG. 4A. Thus, for at least one embodiment, the AP 300 may include system 400 responsible for queuing, contending, and transmitting actual packets onto the wireless medium, and may include virtual system 401 responsible for simulating the queuing, contending, and transmitting of virtual packets and actual packets onto the wireless medium.

FIG. 5B shows a sequence diagram 500B depicting an example simulated contention operation and subsequent transmission of virtual packets and actual packets from the AP 300 of FIG. 3 for the first access category AC0 in accordance with some embodiments. Referring also to FIGS. 4A, 4B, and 5A, the AP 300 may simulate the insertion of a number of virtual packets (not shown for simplicity) in the AC0 queues 410(0), simulate medium access contention operations for the actual packets PKTa-PKTc of FIG. 5A and for the virtual packets belonging to the first access category AC0, and then simulate the transmission of the virtual packets and the actual packets PKTa-PKTc from the AP 300. For some embodiments, the AP 300 may record the time of departure (TOD) of all the virtual packets and/or the actual packets from the AP 300.

For the simulation operation depicted in FIG. 5B, the destination addresses of the packets are not important because there is only one STA associated with the AP 300, so for purposes of discussion of FIG. 5B, the virtual packets are not assigned to individual DA queues within the AC0 queues 410(0). For actual embodiments in which there are multiple STAs associated with the AP 300, the destination addresses may be considered so that the virtual packets and actual packets are assigned to individual DA queues within the various AC0 queues 410(0). In this manner, the present embodiments may provide available capacity estimates on a per-AC basis and on a per-STA basis.

Assuming that the simulated AC0 queues 410(0) contain unlimited virtual packets to send, medium access contention operations between the access categories AC0-AC3 may be simulated by having corresponding contention engines CE0-CE3 select random back-off values and then compete with each other for medium access. At simulation time s₀, the AP 300 does not yet have any actual packets to transmit (e.g., PKTa does not arrive into AC2 queue 410(2) until time tₐ). Thus, contention engine CE0 wins the first contention period, and is granted medium access for the first TXOP at simulation time s₀. The simulated transmission of the first virtual packet from contention engine CE0 is denoted as TXOP1_{AC0} in FIG. 5B.

By simulation time s₁, the actual packet PKTa has been queued in AC2 queue 410(2) of AP 300, and therefore AP 300 has an actual packet to transmit for the second TXOP. Accordingly, after a contention delay (CD) period, the AP 300 simulates medium access contention operations between the access categories. For the example of FIG. 5B, contention engine CE0 wins the second contention period, and is granted medium access for the second TXOP at simulation time s₁. The simulated transmission of the second virtual packet from contention engine CE0 is denoted as TXOP2_{AC0} in FIG. 5B. For some embodiments, the contention delay period may be based, at least in part, on the Arbitration Inter-Frame Spacing (AIFS) duration. For at least one embodiment, the contention delay period may be equal to AIFS+R*S, where R is the random back-off value, and S is the slot time. In this manner, the contention delay periods may vary between TXOPs.

By simulation time s₂, the actual packet PKTb has been queued in AC1 queue 410(1) of AP 300, and therefore AP 300 has two actual packets to transmit for the third TXOP. Accordingly, after a CD period, the AP 300 simulates medium access contention operations between the access categories. For the example of FIG. 5B, contention engine CE0 wins the third contention period, and is granted medium access for the third TXOP at simulation time s₂. The simulated transmission of the third virtual packet from contention engine CE0 is denoted as TXOP3_{AC0} in FIG. 5B.

By simulation time s₃, the AP 300 again simulates medium access contention operations between the access categories. For the example of FIG. 5B, contention engine CE0 wins the fourth contention period, and is granted medium access for the fourth TXOP at simulation time s₃. The simulated transmission of the fourth virtual packet from contention engine CE0 is denoted as TXOP4_{AC0} in FIG. 5B.

By simulation time s₄, the AP 300 again simulates medium access contention operations between the access categories. For the example of FIG. 5B, contention engine CE1 wins the fifth contention period, and is granted medium access for the fifth TXOP simulation time s₄. The transmission of the actual packet PKTb from contention engine CE1 is denoted as PKTb in FIG. 5B.

By simulation time s₅, the AP 300 again simulates medium access contention operations between the access categories. For the example of FIG. 5B, contention engine CE0 wins the sixth contention period, and is granted medium access for the sixth TXOP at simulation time s₅. The simulated transmission of the fifth virtual packet from contention engine CE0 is denoted as TXOP5_{AC0} in FIG. 5B.

By simulation time s₆, the AP 300 again simulates medium access contention operations between the access categories. For the example of FIG. 5B, contention engine CE2 wins the seventh contention period, and is granted medium access for the seventh TXOP at simulation time s₆. The transmission of the actual packet PKTa from contention engine CE2 is denoted as PKTa in FIG. 5B.

By simulation time s₇, the AP 300 again simulates medium access contention operations between the access categories. For the example of FIG. 5B, contention engine CE1 wins the eighth contention period, and is granted medium access for the eighth TXOP at simulation time s₇. The transmission of the third actual packet PKTc from contention engine CE1 is denoted as PKTc in FIG. 5B.

It is noted that although the transmit opportunities (TXOP1-TXOP5) for the virtual packets may be depicted in FIG. 5B as having similar durations, in practice the various TXOPs may be of various durations (e.g., depending at least in part upon which access category each of the virtual packets belongs to). Similarly, although the transmit durations associated with the actual packets PKTa-PKTc may be depicted in FIG. 5B as being of similar lengths, in practice the transmit durations associated with the actual packets PKTa-PKTc may be different. Further, although one or more of the simulation times s₁-s₇ of FIG. 5B may align with one or more of the actual times t₁-t₇ of FIG. 5A, in practice the simulation times of FIG. 5B may not be aligned with the actual times of FIG. 5A.

As shown in FIG. 5B, the example medium access contention operation simulated by the AP 300 for access category AC0 results in virtual packets belonging to AC0 being transmitted from the AP 300 for five of the eight TXOPs, and results in each of the three actual packets PKTa-PKTc being transmitted from the AP 300 for one of the eight TXOPs. It is noted that because the virtual packets belong to access category AC0, which corresponds to higher priority data than access categories AC1 and AC2, inclusion of the AC0 virtual packets in the simulated medium access contention operation may result in the actual packets PKTa-PKTc being transmitted at later times than they were actually transmitted for the “real” operation depicted in FIG. 5A. Once the AP 300 has completed the simulated medium access contention operation, the AP 300 may then determine what percentage of the available time would be available to the new STA for data belonging to access category AC0. For the example of FIG. 5B, the new STA may receive 5/8=62.5% of the available medium share of the AP 300 for AC0 data (e.g., assuming constant durations for all TXOPs associated with the operation depicted in FIG. 5B).

For some embodiments, the TOD of the virtual packets and the actual packets depicted in FIG. 5B may be recorded by circuitry and/or logic within the AP 300 (e.g., by the simulation software module 344 of FIG. 3) to derive the simulated packet transmission schedule, which in turn may be used to generate the per-AC estimates of available medium share.

Conventional solutions may provide a less accurate estimate of available medium share to the new STA. For example, if there are nine STAs currently associated with the AP 300, then estimating available medium share as a function of the number of currently associated STAs would provide an estimate of 1/(9+1)=10% of the available medium to the new STA. However, as described above with respect to FIG. 5B, the portion of the medium available to the new STA for AC0 data would actually be 62.5%. Thus, the present embodiments may provide a more accurate estimate of available capacity than conventional solutions.

The AP 300 may perform additional medium access simulation operations for the other access categories AC1-AC3 in a manner similar to that described above with respect to FIG. 5B, for example, by inserting virtual packets into the AC queues associated with the other access categories AC1-AC3 in their respective virtual systems 402(1)-402(3). In this manner, the AP 300 may provide the new STA with available capacity estimates for each of the access categories AC0-AC3, which in turn may allow the new STA to determine whether to associate with the AP 300 based, at least in part, on how much of its data belongs to each of the access categories AC0-AC3. For at least some embodiments, the simulation operations for each of the access categories AC0-AC3 may be performed by the AP 300 in parallel (e.g., at the same time) using virtual systems 402(0)-402(3) of FIG. 4B, although for other embodiments the simulation operations may be performed sequentially.

As described above, the AP may simulate the effects of an access category (AC) always having traffic available to send. Thus, in the absence of real traffic to send by the AC, the simulated system may assume the presence of a virtual packet of one TXOP duration belonging to the AC. Accordingly, the AP may compute the capacity available to the AC under the assumption of always having traffic to send.

It is noted that the simulated system for each AC, as described above with respect to FIG. 4B, yields an estimate of a per-AC medium share, which is the available medium share for all traffic of that AC. Recognizing that the medium utilization of current users of the AC in the presence of a new STA with full buffer traffic would be lower than their current utilizations (in absence of the new user), the per-AC medium shares determined in the manner described above may be used to determine the available medium share for the new STA for each AC. Thus, for some embodiments, the AP 300 may determine the predicted peak medium share available to a new user (denoted MS_{newuser}) based on the per-AC medium share and information indicating the number of users and/or an amount of the medium share that each of the users utilizes. For one example, if all users have full buffer traffic and use their allocated fair shares of the medium, then the per-user medium share may be determined by dividing the per-AC medium share by the number of users plus one (e.g., where the plus one corresponds to the new STA). For another example, if one or more users do not have full buffer traffic or do not use their allocated fair shares of the medium, then the per-user medium share may be determined by re-distributing the excess per-AC medium share (e.g., corresponding to unused medium share by the one or more users) to the remaining users (e.g., users that have full buffer traffic), and then re-computing the fair share for the remaining users.

For some embodiments, the value of the available medium share of a new STA for an AC may be used to determine the available capacity of the AP in the form of an upper-bound on the downlink throughput that a new STA would receive for traffic of the AC, as per the following equation:

capacity_{AC}=MS_{newuser}*PHYrate*MACeff (1)

where MS_{newuser} is the medium share that a new STA at the AP would receive, PHYrate is a determination of the achievable downlink modulation rate from the AP to the STA, and MACeff is a parameter accounting for the loss in throughput on account of acknowledgements and other MAC-layer overheads.

As per another embodiment, the calculation in equation (1) may use the goodput instead of the PHYrate, where goodput is defined as the product of PHYrate and (1−PER), where PER is the packet error rate at that PHYrate. This is expressed as equation (2) below:

capacity_{AC}=MS_{newuser}*PHYrate*(1−PER)*MACeff (2)

For some embodiments, a STA may estimate the downlink PHYrate achievable by the AP based on a measure of received signal strength indication (RSSI) of a beacon, a probe-response, or any other transmission from the AP in conjunction with the intersection of the set of capabilities advertised by the AP and supported by the STA itself.

The AP 300 may provide the per-AC estimates (and/or per-STA estimates) of available medium share to the new STA in any suitable manner. For at least some embodiments, the AP 300 may include the available medium share and/or capacity estimates in information elements (IEs) contained within beacon frames broadcast from the AP 300 (e.g., at one or more TBTTs). For other embodiments, the AP 300 may include the available medium share and/or capacity estimates in IEs contained within probe response frames sent to the new STA (e.g., in response to probe requests sent by the new STA). For another embodiment, the estimates of available medium share and/or capacity may be provided within access network query protocol (ANQP) messaging elements. For other embodiments, the estimates of available medium share and/or capacity may be provided in association frames, authentication frames, management frames, and/or any other type of frames sent to the new STA. For yet another embodiment, the per-AC estimates (and/or per-STA estimates) of available capacity may be scaled and provided in the available admission capacity field of the BSS load element specified by the IEEE 802.11 standards.

The AP 300 may determine and advertise other metrics that are equivalent or related to the maximum medium utilization available to a new STA. These other metrics may include, but are not limited to: the current medium utilization of each STA along with the projected available medium share for the new STA; available headroom in medium share for existing STAs, the total medium available for the selected AC after adding the new STA's traffic; downlink throughput estimates for the new STA for a specific physical layer rate; bounds on the medium utilization available; inter-service time, jitter in the service, and other related metrics; medium utilization computed at different time-scales of averaging; and any combination of the above metrics.

The AP may compute and advertise the serviceLatency_{AC} as determined in equation (3) via a beacon broadcasted by the AP; or via a probe-response transmitted in response to a probe-request transmitted by a STA; or via an access network query protocol (ANQP) messaging element or via other means.

serviceLatency_{AC}=TXOP_{AC}/MS_{newuser} (3)

Alternately, a STA may estimate an upper-bound on the service latency for a given AC, using parameters advertised by the AP as per equation (3).

In the context of a system in which the medium is shared between the AP's backhaul and the access-link—for example, when the AP and a range extender (not shown for simplicity) communicate on the same channel as the range extender and the STA—downlink traffic to the STA may result in downlink traffic between AP and range extender and range extender and STA. Thus, for at least some embodiments, a serving device such as an AP or range extender would additionally advertise the characteristics of its backhaul. As per an embodiment of the invention, a range extender may advertise its backhaul characteristic as an independent or dependent backhaul, wherein an independent backhaul would not impact the downlink throughput estimate of a STA, while a dependent backhaul would. The range-extender may additionally advertise its achievable PHYrate_{AP} from the AP. A STA associated to a range extender may hence determine the maximum downlink throughput achievable for an AC to account for the effect of a dependent backhaul between the range-extender and the AP. The fraction of medium time available is shared between the downlink from the AP to the range-extender and the downlink between the range-extender to the STA. Thus, the maximum downlink throughput available to an AC of the end station with a dependent backhaul (DLₘₐₓ) may then be expressed as:

DLₘₐₓ=MS_{newuser}*PHYrate_{AP}*PHYrate_{RE}*MACeff/(PHYrate_{AP}+PHYrate_{RE}) (4)

where PHYrate_{AP} is the achievable downlink PHY rate between the AP and the range extender, and PHYrate_{RE} is the achievable downlink PHY rate between the range extender and the STA.

As per another embodiment, the calculation in equation (4) may use the goodput instead of the PHYrate for the AP and the range extender, where goodput is defined as the product of PHYrate and (1−PER), where PER is the corresponding packet error rate at that PHYrate, as expressed in equation (5) below:

DLₘₐₓ=MS_{newuser}*Goodput_{AP}*Goodput_{RE}*MACeff/(Goodput_{AP}+Goodput_{RE}) (5)

To compensate for any burstiness of the traffic load and variability in network conditions, the AP 300 may determine the maximum medium utilization available to a new STA of a particular AC by varying the averaging interval. The AP 300 may employ various averaging techniques (e.g., sliding window and exponentially weighted), and various averaging windows may be applied. For some embodiments, averaging may be performed over multiple time windows, and thus multiple values of the maximum medium utilization (based on varying averaging windows) may be provided by the AP 300, thereby allowing the new STA to determine the variability in network conditions.

It is noted that the operations depicted in FIGS. 5A and 5B do not depict the transmission of acknowledgement (ACK) frames from the recipient of the transmitted data. For the simulated operation of FIG. 5B, the transmit duration of ACK frames may be included within the transmitted data as the sum of the actual transmit duration of the data frame, one short-inter-frame space (SIFS) duration, and the transmit duration of the ACK frame. It would be apparent to one skilled in the art that where relevant the ACK frame may be substituted with the Block ACK frame. For some embodiments, the AP 300 may determine the modulation and coding scheme (MCS) of the ACK frame based on the MCS of the data frames and specified control rates. The AP 300 may also select contention parameters for the virtual packets in a statistical manner, for example, by determining the values of AIFS durations and random back-off values based on the AIFS and contention window (CW) values associated with the WLAN 120.

Referring again to FIGS. 3 and 4B, the virtual system 401 may be implemented in the memory 340 of AP 300 as a set of queues that, once organized by TID and DA, may only store the packet length for each of the simulated packets. The packet length may be specified as a number of bytes or as a duration of time. Further, the lengths of packets transmitted by the AP 300 may be initially stored as a number of Bytes in the virtual system 401, and then converted to a duration of time using the predicted MCS. Alternatively, the conversion from the number of bytes to a duration of time may be based on throughput accounting for, among other factors, the predicted packet error rate (PER) at steady state, and the available transmission modes (e.g., beam-forming, diversity, and so on). For at least some embodiments, in absence of other information, the actual transmission rate may be used as the virtual transmission rate. Thus, packets may be inherently characterized by their transmit durations in the queues of the virtual system 401. The AP 300 may also track the latest MCS used for all associated STAs to determine the transmit duration of packets in the virtual system 401.

The AP 300 may reduce the memory area to implement the virtual system 401 by recognizing that a number of packets destined to the same STA may be aggregated together in the same TXOP. More specifically, the AP 300 may consolidate a number of packet sub-elements in the AC queues 410 as an aggregated packet stored as one element in the corresponding one of AC queues 410. The aggregation of packets may also apply to AC queues 410 corresponding to other STAs (which in turn may require such AC queues 410 to be organized according to DA and TID).

The present embodiments may also consider collisions within the AP 300, for example, resulting when more than one of the contention engines CE0-CE3 selects the same random back-off value. For example, the AP 300 may observe strict priority scheduling in an instance where two internal AC queues collide.

It is also noted that packet errors may influence the available capacity. Thus, for at least some embodiments, the AP 300 may consider the effects of packet error in the simulation operations by creating random packet errors in the simulation operation of FIG. 5B based on the measured packet error rate associated with the actual transmission operation depicted in FIG. 5A. In this manner, the AP 300 may simulate the retransmission of packets in the simulation operation of FIG. 5B.

Further, for some embodiments, the AP 300 may consider wireless traffic associated with other APs and STAs but within wireless range of AP 300 when simulating medium access contention operations. For example, if one or more other APs and STAs are within wireless range of AP 300, then traffic associated with the other APs may influence the amount of available share of the wireless medium, particularly if the other APs are operating on the same channel or frequency band as the AP 300. For such embodiments, the AP 300 may simulate operation of the AC queues and contention engines for the other APs. For such simulation, traffic arrivals at the queues of other APs and/or STAs may be simulated based on the actual transmissions from the other APs and/or STAs observed over the air.

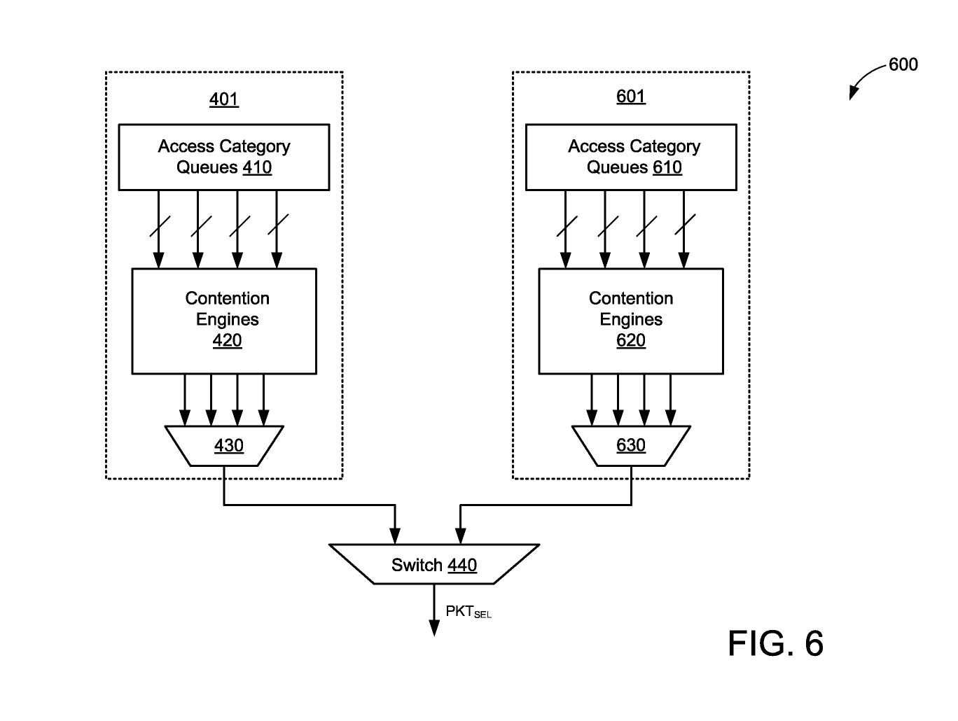

FIG. 6 shows a virtual contention and transmission system 600 that is another embodiment of the virtual contention and transmission system 401 of FIG. 4B. The system 600, which may be implemented within the AP 300 of FIG. 3, is shown to a first portion 401, a second portion 601, and a switch 440. First portion 401, which may be the same as system 401 of FIG. 4B, may be used to simulate traffic associated with AP 300. Second portion 601, which is one embodiment of (and may include all the elements of) system 401 of FIG. 4B, may be used to simulate traffic associated with another AP near the AP 300. The outputs of portions 401 and 601 are provided to inputs of switch 440, which in turn includes an output to provide a select packet PKT_{SEL} to the PHY layer of the AP 300.

More specifically, actual packets and virtual packets associated with the AP 300 may be queued in access category queues 410 of portion 401, and actual packets associated with the other nearby AP may be queued in access category queues 610 of portion 601. The access category queues 610 may be one embodiment of access category queues 410 of FIG. 4A. The contention engines 420 are responsible for contending for medium access for the AP 300, and the contention engines 620 are responsible for contending for medium access for the other nearby AP. The contention engines 420 and 620 depicted in FIG. 6 may operate in a manner similar to that described above with respect to the contention engines 420 of FIG. 4A. Switch 430 may be used to output a packet from the winning one of contention engines 420, and switch 630 may be used to output a packet from the winning one of contention engines 620. For some embodiments, the time of arrival on air of packets from the neighboring AP/STA may be used as an approximate time of arrival in the simulated system 601.

In operation, the first portion 401 may be used to simulate medium access contention operations and the subsequent packet transmission schedule for the AP 300, and the second portion 601 may be used to simulate medium access contention operations and the subsequent packet transmission schedule for the other nearby AP. Contention and transmission operations of the first portion 401 and the second portion 601 are combined in switch 440, which in turn provides packets for simulated transmission on the AP's PHY layer. As a result, the virtual contention and transmission system 600 may provide, in a manner similar to that described above with respect to FIG. 4B, per access category estimates of the available capacity of the AP 300 that consider actual traffic (in real time) associated with the other nearby AP.

An example operation for estimating the available medium share of AP 300 for a new STA is described below with respect to the illustrative flow chart 700 of FIG. 7. Referring also to FIGS. 4A-4B and 5A-5B, the AP 300 may queue a number of actual packets that are scheduled for transmission to one or more STAs that are currently associated with the AP (702), and then may queue a number of virtual packets corresponding to the new STA (704). The AP 300 may then simulate medium access contention operations between the actual packets and the virtual packets (706). Next, the AP 300 may determine a transmission schedule for the actual packets and the virtual packets based on the simulated medium access contention operations (708). The AP 300 may then determine a portion of the available capacity or medium time that is allocated to the virtual packets based, at least in part, on the transmission schedule (710). The AP 300 may then broadcast the portion of the available capacity or medium share to the new STA (712).

In the foregoing specification, the present embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of estimating, for a first station (STA), an amount of available capacity of an access point (AP), the method comprising:
queuing a number of actual packets to be transmitted to one or more second STAs;
queuing a number of virtual packets corresponding to the first STA;
simulating medium access contention operations between the actual packets and the virtual packets;
determining a transmission schedule for the actual packets and the virtual packets based on the simulated medium access contention operations; and
determining a portion of the available capacity that is allocated to the virtual packets based, at least in part, on the transmission schedule.

2. The method of claim 1, wherein the transmission schedule is determined by simulating a transmission of the actual packets and the virtual packets.

3. The method of claim 1, wherein the portion comprises a percentage of the capacity of a wireless medium that is available to the first STA.

4. The method of claim 1, further comprising:
advertising the portion of the capacity available to the first STA.

5. The method of claim 4, wherein the portion of the available capacity is embedded within information elements of a beacon frame, a probe response, or a network query message.

6. The method of claim 1, further comprising:
selecting a priority level for all of the virtual packets;
determining a priority level for each of the actual packets; and
queuing the actual packets and the virtual packets according to their priority levels.

7. The method of claim 6, wherein the portion of the available capacity corresponds to the selected priority level.

8. The method of claim 6, wherein the simulating comprises:
assigning different ranges of contention period back-off values to the actual packets and the virtual packets based on their priority levels.

9. The method of claim 6, wherein the transmission schedule is determined based on the priority levels of the actual packets and the virtual packets.

10. The method of claim 1, further comprising:
determining one or more service metrics based, at least in part, on the determined transmission schedule, wherein the one or more service metrics are selected from a list including service latency, jitter, and capacity headroom available.

11. The method of claim 1, further comprising:
determining a maximum throughput for the first STA based, at least in part, on a modulation rate and a packet error rate associated with transmissions to the first STA.

12. A non-transitory computer-readable medium containing program instructions that, when executed by a processor of an access point (AP), causes the AP to estimate an amount of capacity available to a first station (STA) by performing operations comprising:
queuing a number of actual packets to be transmitted to one or more second STAs;
queuing a number of virtual packets corresponding to the first STA;
simulating medium access contention operations between the actual packets and the virtual packets;
determining a transmission schedule for the actual packets and the virtual packets based on the simulated medium access contention operations; and
determining a portion of the available capacity that is allocated to the virtual packets based, at least in part, on the transmission schedule.

13. The non-transitory computer-readable medium of claim 12, wherein the transmission schedule is determined by simulating a transmission of the actual packets and the virtual packets.

14. The non-transitory computer-readable medium of claim 12, wherein the portion comprises a percentage of the capacity of a wireless medium that is available to the first STA.

15. The non-transitory computer-readable medium of claim 12, wherein execution of the instructions causes the AP to perform operations further comprising:
advertising the portion of the capacity available to the first STA.

16. The non-transitory computer-readable medium of claim 15, wherein the portion of the available capacity is embedded within information elements of a beacon frame, a probe response, or a network query message.

17. The non-transitory computer-readable medium of claim 12, wherein execution of the instructions causes the AP to perform operations further comprising:
selecting a priority level for all of the virtual packets;
determining a priority level for each of the actual packets; and
queuing the actual packets and the virtual packets according to their priority levels.

18. The non-transitory computer-readable medium of claim 17, wherein the portion of the available capacity corresponds to the selected priority level.

19. The non-transitory computer-readable medium of claim 17, wherein the transmission schedule is determined based on the priority levels of the actual packets and the virtual packets.

20. An access point (AP) to estimate an amount of capacity available to a first station (STA), the AP comprising:
means for queuing a number of actual packets to be transmitted to one or more second STAs;
means for queuing a number of virtual packets corresponding to the first STA;
means for simulating medium access contention operations between the actual packets and the virtual packets;
means for determining a transmission schedule for the actual packets and the virtual packets based on the simulated medium access contention operations; and
means for determining a portion of the available capacity that is allocated to the virtual packets based, at least in part, on the transmission schedule.

21. The AP of claim 20, wherein the transmission schedule is determined by simulating a transmission of the actual packets and the virtual packets.

22. The AP of claim 20, wherein the portion comprises a percentage of the capacity of a wireless medium that is available to the first STA.

23. The AP of claim 20, further comprising:
means for advertising the portion of the capacity available to the first STA.

24. The AP of claim 23, wherein the portion of the available capacity is embedded within information elements of a beacon frame, a probe response, or a network query message.

25. The AP of claim 20, further comprising:
means for selecting a priority level for all of the virtual packets;
means for determining a priority level for each of the actual packets; and
means for queuing the actual packets and the virtual packets according to their priority levels.

26. The AP of claim 25, wherein the portion of the available capacity corresponds to the selected priority level.

27. The AP of claim 25, wherein the means for simulating medium access contention operations is to assign different ranges of contention period back-off values to the actual packets and the virtual packets based on their priority levels.

28. The AP of claim 25, wherein the transmission schedule is determined based on the priority levels of the actual packets and the virtual packets.

29. The AP of claim 20, further comprising:
means for determining one or more service metrics based, at least in part, on the determined transmission schedule, wherein the one or more service metrics are selected from a list including service latency, jitter, and capacity headroom available.

30. The AP of claim 20, further comprising:
means for determining a maximum throughput for the first STA based, at least in part, on a modulation rate and a packet error rate associated with transmissions to the first STA.
